(19) United States
(12) Patent Application Publication
(10) Pub. No.: US 2025/0182971 A1
(43) Pub. Date: Jun. 5, 2025

(54) ELECTRONIC COMPONENT, CIRCUIT BOARD ARRANGEMENT, ELECTRONIC DEVICE, AND METHOD OF MANUFACTURING ELECTRONIC COMPONENT

(71) Applicant: TAIYO YUDEN CO., LTD., Tokyo (JP)

(72) Inventors: Ryosuke HOSHINO, Tokyo (JP); Satoshi KOBAYASHI, Tokyo (JP)

(73) Assignee: TAIYO YUDEN CO., LTD., Tokyo (JP)

(21) Appl. No.: 19/046,361

(22) Filed: Feb. 5, 2025

Related U.S. Application Data
(63) Continuation of application No. PCT/JP2023/015072, filed on Apr. 13, 2023.

(30) Foreign Application Priority Data
Aug. 10, 2022 (JP) 2022-127653

(51) Int. Cl. H01G 4/232; H01G 2/06; H01G 4/008; H01G 4/224; H01G 4/30

(52) U.S. Cl. CPC H01G 4/2325; H01G 2/065; H01G 4/008; H01G 4/224; H01G 4/30

(57) ABSTRACT

An electronic component includes an element body having a contour having a pair of end faces and multiple lateral faces each of which is connected to the end faces and extends from one of the end faces to another of the end faces, and at least one conductor within the element body; base layers each of which is in contact with the lateral faces and one of the end faces; and Ni layers formed on the base layers, respectively, each of the Ni layers disposed over the lateral faces and the corresponding end face. Each of the Ni layers has at least one thickest portion disposed over at least one of the lateral faces, and a thickness of the thickest portion is at least 30 percent greater than a thickness of a portion of the Ni layer disposed over the corresponding end face.

### CROSS-REFERENCE TO RELATED APPLICATIONS

This application is a bypass continuation of International Application No. PCT/JP2023/015072, filed Apr. 13, 2023, which claims the benefit of Japanese Application No. 2022-127653, filed Aug. 10, 2022, in the Japanese Patent Office. All disclosures of the documents named above are incorporated herein by reference.

### TECHNICAL FIELD

The present invention relates to electronic components, circuit board arrangements, electronic devices, and methods of manufacturing electronic components.

### BACKGROUND ART

Surface mount components (chip components) are known as electronic components such as multilayer ceramic capacitors and multilayer inductors, which have internal conductors such as electrodes and windings and external electrodes connected to the internal conductors. The surface mount component is mounted on a substrate by bonding the external electrodes to the substrate using, for example, solder.

For example, Patent Document JP 2015-39014 A discloses a multilayer ceramic capacitor that has sintered electrodes (Cu layers) formed from a conductive paste containing glass components and Cu powder, Ni plating layers formed on the surfaces of the Cu layers, and Sn plating layers formed on the Ni plating layers.

### SUMMARY OF THE INVENTION

If the adhesion of the Ni plating layers to the Cu layers is insufficient, moisture may penetrate therebetween to cause moisture degradation of the electronic component. The adhesion can be improved by increasing the thickness of the Ni plating layers, but if the Ni plating layers are too thick, the residual stress will increase and cause heat cycle cracks or bending cracks.

Accordingly, the present invention aims to reduce both moisture degradation and cracking.

To solve the above problems, in accordance with an aspect of the present invention, there is provided an electronic component including an element body having a contour having a pair of end faces and multiple lateral faces each of which is connected to the end faces and extends from one of the end faces to another of the end faces, and at least one conductor within the element body; base layers each of which is in contact with the lateral faces and one of the end faces; and Ni layers formed on the base layers, respectively, each of the Ni layers disposed over the lateral faces and the corresponding end face. Each of the Ni layers has at least one thickest portion disposed over at least one of the lateral faces, and a thickness of the thickest portion is at least 30 percent greater than a thickness of a portion of the Ni layer disposed over the corresponding end face.

In one embodiment of the present invention, each of the base layers is a Cu layer.

In one embodiment of the present invention, the electronic component further includes an upper metal layers formed on the Ni layers, respectively.

In one embodiment of the present invention, each of the base layers is a Cu layer and each of the upper metal layers is an Sn layer.

In one embodiment of the present invention, the thickness of the thickest portion is at least 20 percent greater than a thickness of at least one thinnest portion disposed over at least one of the lateral faces.

In one embodiment of the present invention, each of the Ni layers has the thickest portions that are located over the lateral faces and that are located farther from the corresponding end face than a middle between an edge farthest from the corresponding end face and an edge closest to the corresponding end face.

In one embodiment of the present invention, the element body has first lateral faces connected to the end faces and second lateral faces each of which is connected to the first lateral faces and the end faces, and each of the Ni layer has the thickest portions disposed over boundaries between the first lateral faces and the second lateral faces.

In one embodiment of the present invention, the thickness of the thickest portion of each of the Ni layers is from 3.5 to 5.5 micrometers.

In one embodiment of the present invention, the thickness of the portion of each of the Ni layers disposed over the corresponding end face is from 2.5 to 4.0 micrometers.

In one embodiment of the present invention, the thickness of the thinnest portion of each of the Ni layers is at least 3.0 micrometers.

In one embodiment of the present invention, the thickness of the portions of each of the Ni layers farthest from the corresponding end face is at least 30 percent greater than a thickness of portions of the Ni layer disposed over boundaries between the end face and each of the lateral faces.

To solve the above problems, according to another aspect of the present invention, there is provided a circuit board arrangement that includes any of the above electronic components and a substrate on which the electronic component is mounted via solders.

To solve the above problems, according to another aspect of the present invention, there is provided an electronic device that includes the above circuit board arrangement.

To solve the above problems, according to another aspect of the present invention, there is provided a method of manufacturing an electronic component, the method including forming base layers on an element body that has a contour having a pair of end faces and multiple lateral faces each of which is connected to the end faces and extends from one of the end faces to another of the end faces, and at least one conductor within the element body, in which each of the base layers is in contact with the lateral faces and one of the end faces; reducing a thickness of at least a portion of each of the base layers, the portion being in contact with at least one of the lateral faces; forming Ni layers on the base layers, respectively, in which each of the Ni layers is disposed over the lateral faces and the corresponding end face.

According to one embodiment of the present invention, reducing the thickness is performed by a blasting treatment.

According to the present invention, both moisture degradation and cracking can be reduced.

### BRIEF DESCRIPTION OF THE DRAWINGS

FIGS. 1A and 1B are perspective views showing an example of a structure of a capacitor according to a first embodiment of the present invention.

FIG. 2 is a cross-sectional view showing the capacitor according to the first embodiment.

FIG. 3 is a schematic diagram for describing reasons for crack generation.

FIG. 4 is a graph showing measured thicknesses of the Ni layers.

FIG. 5 is a flowchart showing a method of manufacturing the capacitor according to the first embodiment.

FIG. 6 is a first cross-sectional view showing the manufacturing method for the capacitor according to the first embodiment.

FIG. 7 is a second cross-sectional view showing the manufacturing method for the capacitor according to the first embodiment.

FIG. 8 is a third cross-sectional view showing the manufacturing method for the capacitor according to the first embodiment.

FIG. 9 is a fourth cross-sectional view showing the manufacturing method for the capacitor according to the first embodiment.

FIG. 10 is a fifth cross-sectional view showing the manufacturing method for the capacitor according to the first embodiment.

FIG. 11 is a sixth cross-sectional view showing the manufacturing method for the capacitor according to the first embodiment.

FIG. 12 is a graph showing a difference in thickness of a base layer (Cu layer) with and without blasting treatment.

FIG. 13 is a graph showing a difference in thickness of an Ni layer with and without blasting treatment.

FIGS. 14A and 14B are cross-sectional views showing a capacitor according to a second embodiment.

FIGS. 15A and 15B are cross-sectional views showing a capacitor according to a third embodiment.

FIG. 16 is a cross-sectional view of a capacitor according to a fourth embodiment.

FIG. 17 is a cross-sectional view of a capacitor according to a fifth embodiment.

FIGS. 18A and 18B are cross-sectional views showing an example of a chip inductor according to a sixth embodiment.

### DESCRIPTION OF EMBODIMENTS

Hereinafter, with reference to the accompanying drawings, embodiments of the present invention will be described in detail. It is of note that the following embodiments do not limit the present invention, and not all of the combinations of features in the embodiments are necessarily essential to the structure of the present invention. The structures of the embodiments may be modified or changed as appropriate depending on the specifications of the device to which the present invention is applied and various conditions (such as usage conditions and usage environments).

The technical scope of the present invention is defined by the scope of the claims and is not limited by the following individual embodiments. The drawings referred to in the following description may differ from the actual structure in terms of scale, shape, etc. for easy understanding of the structures. The structural elements shown in the drawings described earlier may be referred to as appropriate in the description of the later drawings.

### First Embodiment

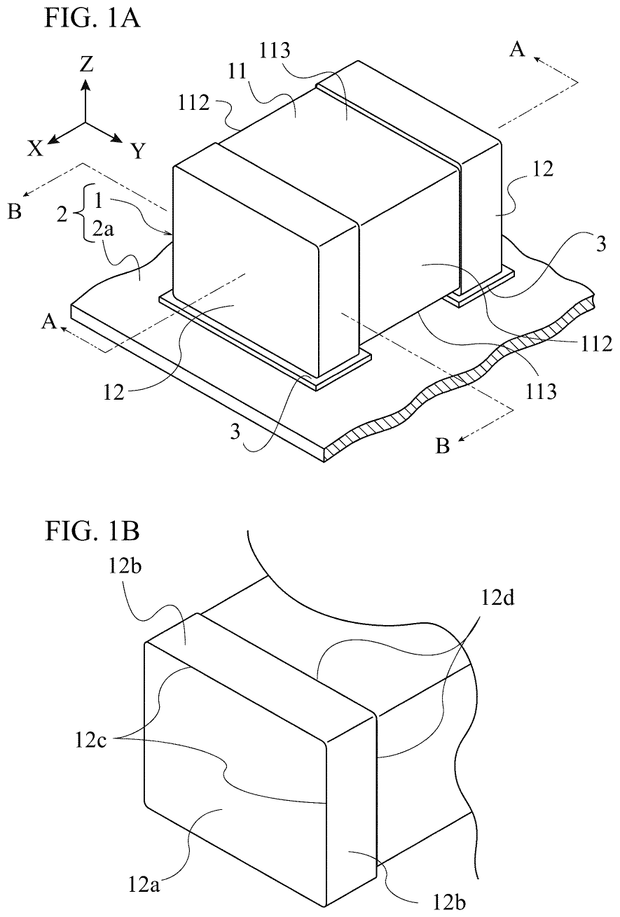

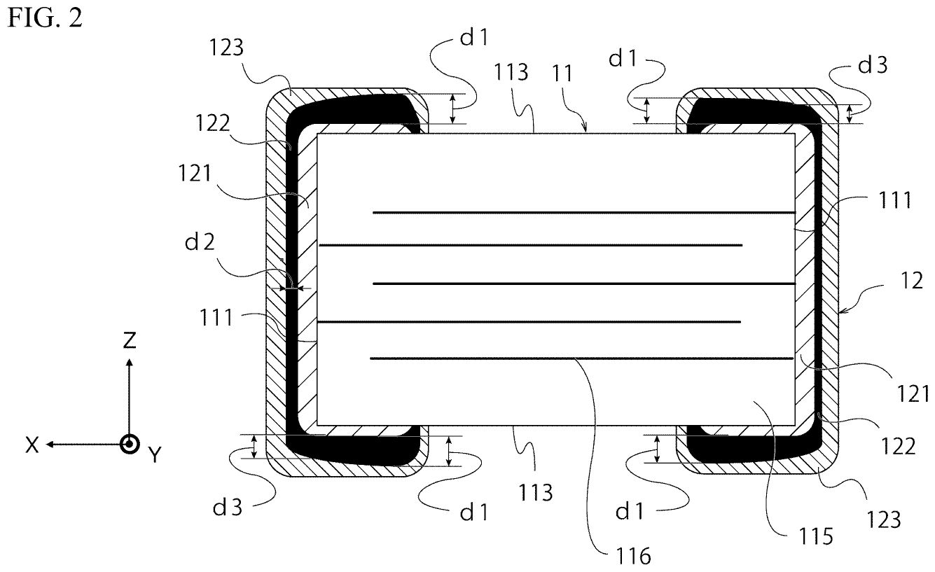

FIGS. 1A, 1B, and 2 show an example of the structure of a capacitor according to a first embodiment of the present invention. FIGS. 1A and 1B show perspective views, and FIG. 2 shows a cross-sectional view along line A-A in FIG. 1A. In this embodiment, a capacitor 1 is used as an example of an electronic component.

The capacitor 1 according to this embodiment is, for example, a multilayer ceramic capacitor, and has an element body 11 and a pair of external electrodes 12.

As shown in FIG. 1A, a circuit board arrangement 2 according to an embodiment of the present invention includes the capacitor 1 and a substrate 2a on which the capacitor 1 is mounted. The substrate 2a has land portions 3. The capacitor 1 is mounted on the substrate 2a by soldering the external electrodes 12 to the land portions 3, respectively.

The circuit board arrangement 2 may be provided in various electronic devices. Electronic devices that use the circuit board arrangement 2 may include electrical components in automotive vehicles, servers, board computers, and various other electronic devices.

In this specification, unless otherwise understood from the context, expression of directions are based on the X-axis direction, Y-axis direction, and Z-axis direction in FIG. 1A, and they are referred to as the “length” direction, “width” direction, and “height” direction, respectively. The “height” direction may also be referred to as the “thickness” direction. The capacitor 1 is mounted on the substrate 2a such that one side of the capacitor 1 in the height direction Z (the lower side in FIG. 2) faces the substrate 2a.

The capacitor 1 has a rectangular parallelepiped shape, and the element 11 also has a rectangular parallelepiped shape. However, some of faces of the capacitor 1 and the element 11 may be flat, curved, or stepped. In addition, some of the eight vertices and twelve edges of the capacitor 1 and the element body 11 may be rounded or chamfered. The external size of the capacitor 1 is preferably in a range from “0201” according to the Japanese Industrial Standards (JIS) (length=0.25 mm, width=0.125 mm) to “4532” according to the JIS (length=4.5 mm, width=3.2 mm), but it may be any other size.

In this specification, even if some of the faces of the capacitor 1 and the element body 11 are curved or uneven and/or even if some of the vertices and edges of the capacitor 1 and the element body 11 are rounded or chamfered, the contour of the capacitor 1 and element body 11 may be referred to as a “rectangular parallelepiped.” In other words, the term “rectangular parallelepiped” used herein does not necessarily mean a rectangular parallelepiped in the strict mathematical sense.

The element body 11 has end faces 111 at both ends thereof in the length direction X, and the two end faces 111 are arranged opposite to each other. The element body 11 also has first lateral faces 112 at both ends thereof in the width direction Y, and second lateral faces 113 at both ends thereof in the height direction Z. The second lateral faces 113 are surfaces on which pressure is mainly exerted when the element body 11 is pressed in manufacturing the capacitor 1. The first lateral faces 112 are cut surfaces that have been cut in manufacturing the capacitor 1.

Each of the first lateral faces 112 and the second lateral faces 113 is a surface that is connected to the end faces 111 and extends from one of the end faces 111 to the other of the end faces 111. Each of the second lateral faces 113 is a surface that is connected to both the first lateral faces 112 and both the end faces 111.

The element body 11 has an internal structure that has dielectric layers 115 and internal electrodes 116.

The main component of the material for the dielectric layers 115 may be, for example, a ceramic material having a perovskite structure. The main component may be contained in a ratio of 50 atomic percent or more. The ceramic material of the dielectric layers 115 may be, for example, barium titanate, strontium titanate, calcium titanate, magnesium titanate, barium strontium titanate, barium calcium titanate, calcium zirconate, barium zirconate, calcium titanate zirconate, or titanium oxide.

The internal electrodes 116 are stacked alternately in such a manner that the dielectric layers 115 are interposed therebetween. Although FIG. 2 shows an example in which five layers of internal electrodes 116 are stacked in total, the number of stacked layers of the internal electrode 116 is not limited.

The material for the internal electrodes 116 may be a metal, for example, Cu (copper), Fe (iron), Zn (zinc), Al (aluminum), Ni (nickel), Pt (platinum), Pd (palladium), Ag (silver), Au (gold), or Sn (tin), or may be an alloy containing at least one of the metals. Each of the internal electrodes 116 extends in the XY plane along the second lateral faces 113. Each of the internal electrodes 116 reaches one of the end faces 111 of the element body 11. The internal electrodes 116 are connected alternately to one and the other of the pair of external electrodes 12. In the width direction Y, both ends of each of the internal electrodes 116 are covered with the dielectric material used for the dielectric layers 115.

The pair of external electrodes 12 are formed on the longitudinal ends of the element body 11, so that they are separated from each other in the length direction X. Each of the external electrodes 12 is formed to cover the corresponding end face 111 of the element body 11, the neighboring portions of the first lateral faces 112, and the neighboring portions of the second lateral faces 113. The thickness of each of the external electrodes 12 is, for example, from 10 to 40 micrometers.

As shown in FIG. 1B, the portion of the external electrode 12 that covers the end face 111 of the element body 11 may be referred to as an “end-face covering portion 12a”, and the portions of the external electrode 12 that cover the first lateral faces 112 or second lateral faces 113 may be referred to as “lateral-face covering portions 12b”. In addition, in each of the lateral-face covering portions 12b of the external electrodes 12, the portion adjacent to the corresponding end face 111 may be referred to as a “proximal portion 12c”, and the portion farthest from the corresponding end face 111 may be referred to as a “distal portion 12d”.

Each of the external electrodes 12 includes a base layer 121, an Ni layer 122, and an upper metal layer 123. The material for the base layer 121 contains a glass component (Si (silicon)) and the main component of the material may be a metal, for example, Cu, Fe, Zn, Al, Pt, Pd, Ag, Au, or Sn, or may be an alloy containing at least one of the metals. The glass component dispersed like islands in the base layer 121 reduces the difference in thermal expansion coefficients of the element body 11 and the base layer 121 to alleviate thermal stress exerted in the base layer 121. The base layer 121 is in contact with the corresponding end face 111, the first lateral faces 112, and the second lateral faces 113. It is preferable that the base layer 121 have excellent adhesiveness with the outer faces of the element body 11 and the internal electrodes 116. For this purpose, it is particularly preferable that the base layer 121 be a Cu layer.

The Ni layer 122 is formed by, for example, plating, and is mainly composed of Ni. The Ni layer 122 protects the corresponding base layer 121. The Ni layer 122 covers the corresponding base layer 121 that covers the corresponding end face 111, the first lateral faces 112, and the second lateral faces 113. In addition, the Ni layer 122 may extend beyond the corresponding base layer 121 and may be in contact with the first lateral faces 112 and the second lateral faces 113 of the element body 11 near the distal portions 12d.

The material for the upper metal layer 123 may be a metal, for example, Cu, Fe, Zn, Al, Pt, Pd, Ag, Au, or Sn, or may be an alloy containing at least one of the metals. The upper metal layer 123 is formed by, for example, plating. The upper metal layer 123 covers the Ni layer 122, and can improve the wettability of the solder that bonds the external electrode 12 of the capacitor 1 to the substrate 2a. For this purpose, it is particularly preferable that the upper metal layer 123 be an Sn layer. However, it is of note that the upper metal layer 123 is not absolutely necessary in the electronic component according to the present invention.

In the capacitor 1 according to this embodiment, the thickness of the Ni layer 122 differs depending on positions in the external electrode 12. More specifically, in the lateral-face covering portions 12b of the external electrode 12, the thickness d1 near the distal portions 12d is different from the thickness d3 near the proximal portions 12c, and the thickness d1 near the distal portions 12d is greater than the thickness d3 near the proximal portions 12c. In addition, the thicknesses d1 and d3 in the lateral-face covering portions 12b are different from the thickness d2 in the end-face covering portion 12a, and the thicknesses d1 and d3 in the lateral-face covering portions 12b are greater than the thickness d2 in the end-face covering portion 12a. In other words, the thickness of the Ni layer 122 is less in the end-face covering portion 12a, and the thickest portions of the Ni layer 122 in the lateral-face covering portions 12b exist near the distal portions 12d. As a result, both moisture degradation and cracking are reduced. The thicknesses d1 and d3 are the thicknesses measured from the surface of the Ni layer 122 in contact with the base layer 121 to the opposite surface of the Ni layer 122 in directions perpendicular to the second lateral faces 113, as shown in FIG. 2. In addition, the thickness d2 is the thickness measured from the surface of the Ni layer 122 in contact with the base layer 121 to the opposite surface of the Ni layer 122 in directions perpendicular to the end faces 111, as shown in FIG. 2.

The term “near the distal portions 12d” may be considered as areas from the middle between the distal portions 12d and the proximal portions 12c to the distal portions 12d. The term “near the proximal portions 12c” may be considered as areas from the middle between the distal portions 12d and the proximal portions 12c to the proximal portions 12c.

FIG. 2 shows the thicknesses d1 and d3 of portions of the Ni layer 122 that cover the second lateral faces 113, but the thicknesses d1 and d3 of portions of the Ni layer 122 that cover the first lateral faces 112 are the same as those in FIG. 2.

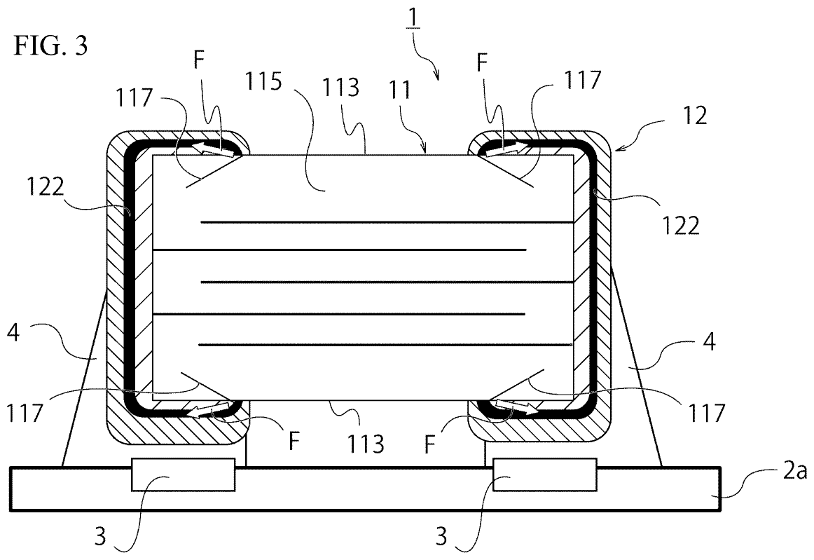

FIG. 3 is a schematic diagram for describing reasons for crack generation.

As described above, the capacitor 1 is connected to the land portions 3 on the substrate 2a via solders 4. The capacitor 1 mounted on the substrate 2a is subjected to a heat cycle test. In the heat cycle test, stress is exerted in the external electrodes 12 due to the difference in thermal expansion between different materials. In addition, if the Ni layers 122 are thick, a large internal stress (residual stress) remains in the external electrodes 12.

A total stress F resulting from the internal stress and the stress caused by the heat cycle test is concentrated particularly in the distal portions 12d of the lateral-face covering portions 12b of the external electrode 12. If the stress F exceeds the strength of the dielectric layers 115 of the element body 11, cracks 117 will occur in the element body 11. Such cracks 117 are likely to occur on the second lateral faces 113 of the element body 11. In particular, cracks 117 caused by heat cycle testing are likely to occur on the second lateral face 113 that is opposite from the substrate 2a.

The capacitor 1 mounted on the substrate 2a is also subject to stress caused by bending of the substrate 2a. The stress caused by bending is applied to the external electrodes 12 via the solders 4, and if the total stress F, which is the combination of this stress and the internal stress of the external electrodes 12, exceeds the strength of the dielectric layers 115 of the element body 11, cracks 117 will also occur in the element body 11. Cracks 117 caused by bending are likely to occur on the second lateral face 113 on the side of the substrate 2a.

As described above, in the capacitor 1 according to this embodiment, the thickness of the portions of the Ni layers 122 over the end face is reduced, so that the internal stress is also reduced, and the stress F caused by heat cycle testing and bending of the substrate 2a is small. As a result, the occurrence of cracks 117 is reduced. In addition, since the thicknesses of the Ni layer 122 in the lateral-face covering portions 12b are greater than the thickness in the end-face covering portion 12a, moisture penetration at the distal portions 12d of the lateral-face covering portions 12b is prevented, and therefore moisture degradation is reduced. In particular, as shown in FIG. 2, since the thickness d1 near the distal portions 12d is greater than the thickness d3 near the proximal portions 12c, the capacitor 1 has a high effect on both preventing moisture from entering the distal portions and reducing internal stress.

Next, specific thicknesses of the Ni layer 122 will be described.

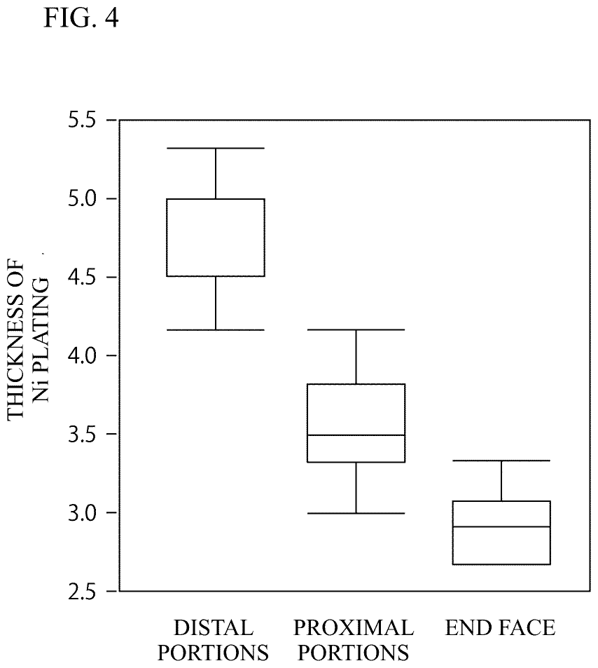

FIG. 4 is a graph showing measured thicknesses of the Ni layers 122.

The graph in FIG. 4 shows the measurement results in samples in which sufficient reduction was achieved for both moisture degradation and cracking.

The Ni layer 122 formed by plating has a thickness d1 in a range of, e.g., 4.2 to 5.3 micrometers near the distal portions 12d, a thickness d3 in a range of, e.g., 3.0 to 4.2 micrometers near the proximal portions 12c, and a thickness d2 in a range of, e.g., 2.7 to 3.3 micrometers in the end-face covering portion 12a.

As a result of a detailed study by the inventors, it was found that if the thickness of the Ni layer 122 at the thickest portions of the lateral-face covering portions 12b (in the example of FIG. 2, the thickness d1 of the Ni layer 122 near the distal portions 12d) is 30 percent or more greater than the thickness d2 of the Ni layer 122 in the end-face covering portion 12a, both moisture degradation and cracking are sufficiently reduced.

If the thickness d2 of the Ni layer 122 in the end-face covering portion 12a is from 2.5 to 4.0 micrometers, the capacitor 1 is highly effective in reducing internal stress.

If the thickness of the thinnest portions of the Ni layer 122 in the lateral-face covering portions 12b is at least 3.0 micrometers, moisture degradation is effectively reduced. If the thickness of the thickest portions of the Ni layer 122 in the lateral-face covering portions 12b is from 3.5 to 5.5 micrometers, it is effective for both reducing moisture degradation and reducing internal stress. It is desirable that the thickness of the thickest portions is at least 20 percent greater than the thickness of the thinnest portions.

### Manufacturing Method

The following describes a manufacturing method for the capacitor 1 that includes the Ni layers 122 having the thicknesses distribution described above.

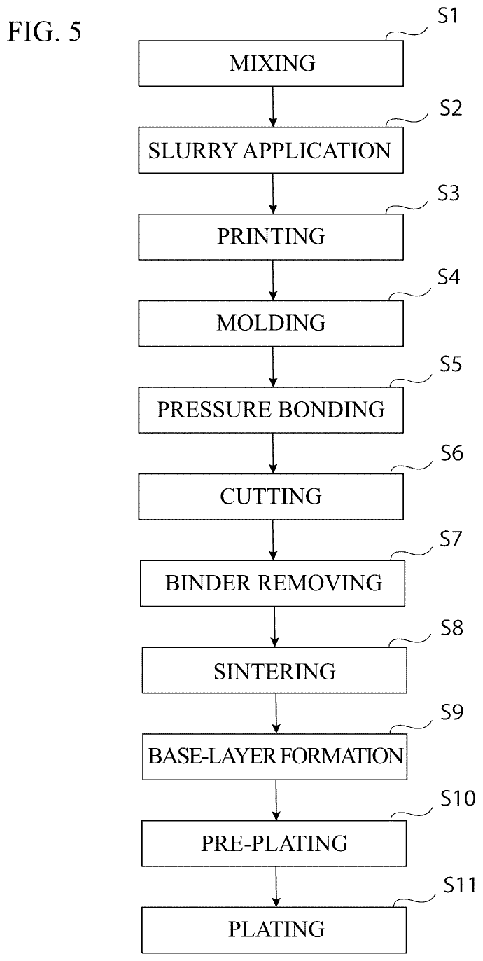

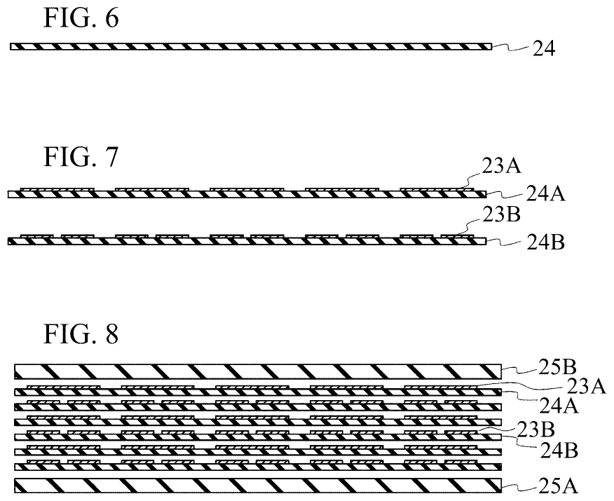

FIG. 5 is a flowchart showing a method of manufacturing the capacitor 1 according to the first embodiment. FIGS. 6 to 11 are cross-sectional views showing the manufacturing method for the capacitor 1 according to the first embodiment. However, for the sake of illustration, the number of layers of the internal electrodes is not accurate.

In the mixing step (S1) of FIG. 5, an organic solvent and an organic binder, which acts as a dispersant and a forming aid, are added to a dielectric material powder, and the powder is pulverized and mixed together with the organic solvent and the organic binder to produce a muddy slurry. The dielectric material powder includes, for example, a ceramic powder. The dielectric material powder may also contain an additive or additives. The additive(s) may be, for example, oxides of Mg, Mn, V, Cr, Y, Sm, Eu, Gd, Tb, Dy, Ho, Er, Tm, Yb, Co, Ni, Li, B, Na, K or Si or glass. The organic binder is, for example, polyvinyl butyral resin or polyvinyl acetal resin. The organic solvent is, for example, ethanol or toluene.

Next, in the slurry application step (S2) of FIG. 5, as shown in FIG. 6, the slurry containing the ceramic powder is applied in a sheet form onto a carrier film and dried to produce a green sheet 24. The carrier film is, for example, a PET (polyethylene terephthalate) film. The application of the slurry is conducted with the use of, for example, a doctor blade method, a die coater method, or a gravure coater method.

Next, in the printing step (S3) of FIG. 5, as shown in FIG. 7, a conductive paste, which will become internal electrodes, is applied onto green sheets 24A and 24B in predetermined patterns to form internal electrode patterns 23A and 23B. At this time, multiple internal electrode patterns 23A or 23B are formed on a single green sheet 24A or 24B, such that the internal electrode patterns 23A or 23B are separated from each other in the longitudinal direction of the green sheet 24A or 24B.

The conductive paste for the internal electrodes includes a powder of the metal used as the material for the internal electrodes 116. For example, if the metal used as the material for the internal electrodes 116 is Ni, the conductive paste for internal electrodes includes a powder of Ni. The conductive paste for the internal electrodes also contains a binder, a solvent, and, if necessary, an auxiliary agent. The conductive paste for the internal electrode layers may include, as a co-material, a ceramic material that is the same as the main component of the dielectric layers 115. The application of the conductive paste for the internal electrode layers may be conducted with the use of a screen printing method, an inkjet printing method, or a gravure printing method.

Next, in the molding step (S4) of FIG. 5, as shown in FIG. 8, the green sheets 24A and 24B, on which the internal electrode patterns 23A and 23B are formed, and green sheets 25A and 25B used as outer layers, on which the internal electrode patterns 23A and 23B are not formed, are laminated. The green sheets 24A, 24B, 25A, and 25B are stacked in a predetermined order and in a predetermined number to create a laminated block.

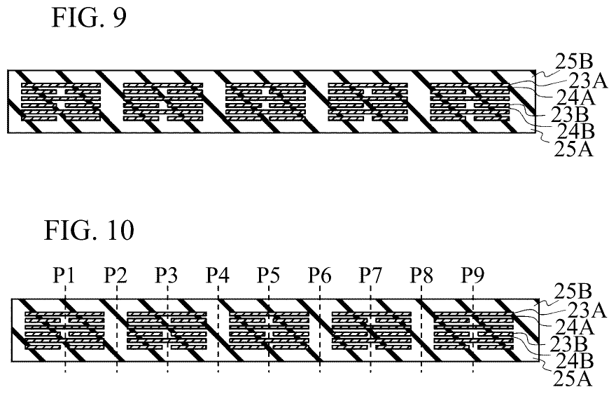

Next, in the pressure bonding step (S5) of FIG. 5, the laminated block is pressed such that the green sheets 24A, 24B, 25A, and 25B are pressure-bonded as shown in FIG. 9. Pressing the laminated block may be conducted by, for example, sandwiching the laminated block between resin films, and hydrostatically pressing the laminated block.

Next, in the cutting step (S6) of FIG. 5, the pressed laminated block is cut such that the block is separated into a plurality of element bodies, each of which has a rectangular parallelepiped shape, as shown in FIG. 10. The cutting of the laminated block is conducted by, for example, blade dicing or a similar method.

Next, in the binder removing step (S7) of FIG. 5, the binder contained in each of the element bodies is removed by heating. In the binder removing step, for example, the element bodies are heated in an N₂ atmosphere at about 350 degrees Celsius.

Next, in the sintering step (S8) of FIG. 5, the element bodies are sintered such that the internal electrodes 116 and the dielectric layers 115 are integrated. The sintering step of the element bodies 11 is conducted in, for example, a sintering furnace in a temperature range from 1000 degrees Celsius to 1400 degrees Celsius for ten minutes to two hours. If a base metal such as Ni or Cu is used as the material for the internal electrodes 116, the sintering step may be conducted in the sintering furnace while the interior of the sintering furnace is kept to a reducing atmosphere in order to prevent oxidation of the internal electrodes 116.

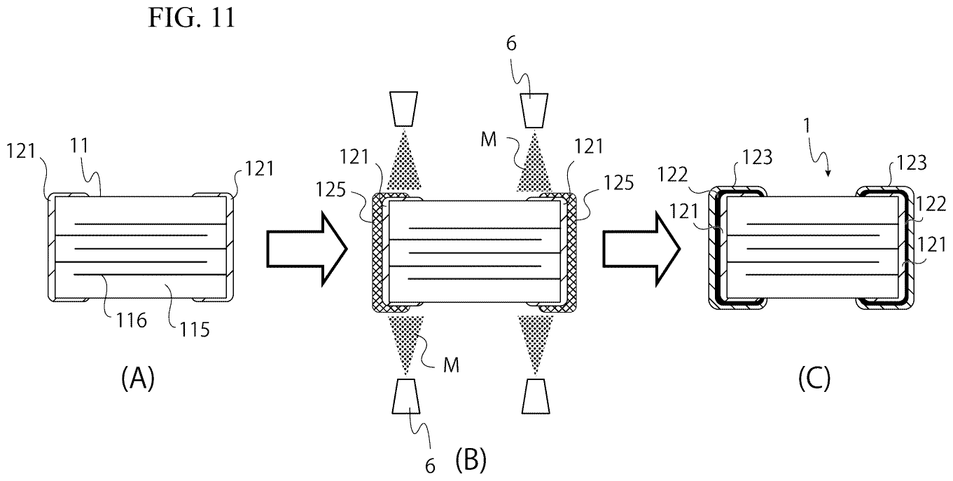

Next, in the base-layer formation step (S9) of FIG. 5, a conductive paste, which will become the base layers, is applied onto both of the end faces 111, the first lateral faces 112, and the second lateral faces 113 of the substrate, and then dried. For example, a dipping method is used to apply the conductive paste for the base layers. The conductive paste for the base layers includes a powder or filler of the metal that is used as the conductive material for the base layers 121. For example, if the metal used as the conductive material of the base layers 121 is Cu, the conductive paste for the base layers contains a powder or filler of Cu. The conductive paste for the base layer also contains a glass component as a co-material. The conductive paste for the base layers further contains a binder and a solvent. After the conductive paste for the base layers is applied, it is dried and then sintered at 700-900 degrees Celsius, so that the base layers 121 are formed as shown in part (A) of FIG. 11.

Next, in the pre-plating step (S10) of FIG. 5, the base layers 121 are covered with masking materials 125, except for the distal portions 12d of the lateral-face covering portions 12b as shown in part (B) of FIG. 11. Then, blasting is performed on the base layers 121 at the distal portions 12d. More specifically, blast media M are projected from nozzles 6 toward the base layer 121 at the lateral-face covering portions 12b so as to polish the base layers 121 at the distal portions 12d. Therefore, the thickness of the base layers 121 at the distal portions 12d is reduced.

Before polishing, the surfaces of the base layers 121 are dotted with glass components, which inhibit the adhesion of Ni plating, whereas the glass components are removed from the polished parts of the base layers 121, so that the adhesion of Ni plating is improved.

In the blasting step, the media projection pressure, the media projection amount, the media type, and the blasting time can be adjusted to adjust the processed state of the base layers 121. In addition, the positions and ranges of the masking materials 125 can be adjusted to adjust the locations of the base layers 121 to be processed. After the blasting step, the masking materials 125 are removed.

In the pre-plating step, chemical polishing or physical grinding may be performed instead of blasting. In chemical polishing and physical grinding, the locations to be treated are also restricted by the masking materials 125.

In a case in which chemical polishing is performed in the pre-plating step, the type of chemical solution, the concentration of the polishing solution, the agitation speed, and the immersion time can be adjusted to adjust the processed state of the base layers 121. In a case in which physical grinding is performed in the pre-plating step, the type of abrasive, the input amount of the element bodies, the vibration frequency, and the grinding time can be adjusted to adjust the processed state of the base layers 121.

Next, in the plating step (S11) of FIG. 5, the Ni layers 122 and the upper metal layers 123 are formed sequentially on the base layers 121 by plating, as shown in part (C) of FIG. 11, so that the capacitor 1 is obtained. In the plating step, for example, the element body provided with the base layers 121 is placed in a barrel together with the plating solution, and the barrel is rotated and energized to form the Ni layers 122 or the upper metal layers 123.

As described above, since the adhesion of Ni plating is improved in the locations that are polished in the pre-plating step (S10), the thickness of the Ni layers 122 in that locations is greater than that in the other locations in which polishing has been prevented by the masking materials 125. In addition, among the locations that have been covered with masking materials 125, the Ni layers 122 in the lateral-face covering portions 12b are thicker than the Ni layer 122 in the end-face covering portions 12a. As a result, the relationship between the thicknesses d1, d2, and d3 described above with reference to FIGS. 2 and 3 is obtained.

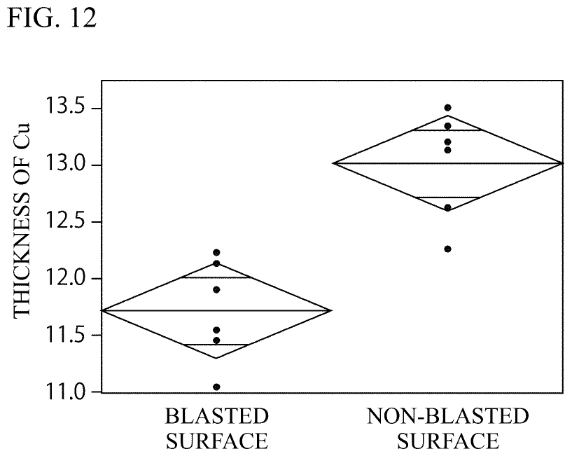

FIG. 12 is a graph showing a difference in thickness of the base layer (Cu layer) 121 with and without the blasting treatment.

In a portion having surfaces that have not undergone blasting treatment (non-blasted surfaces), for example, the end-face covering portion 12a, the thickness of the base layer (Cu layer) 121 is in a range from 12.3 to 13.5 micrometers centered on approximately 13 micrometers. In contrast, in the portions having the surfaces that have been blasted (blasted surfaces), the thickness of the base layer (Cu layer) 121 is in a range from 11.0 to 12.3 micrometers centered on approximately 11.7 micrometers. To increase the thickness of the Ni layer 122 in the locations in which the base layer 121 has been polished, it is preferable that the thickness of the base layer 121 be reduced by more than 10 percent by polishing.

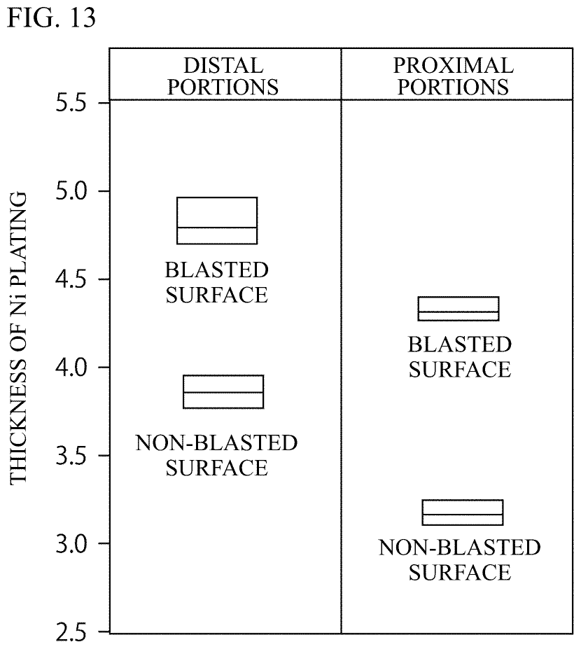

FIG. 13 is a graph showing a difference in thickness of the Ni layer 122 with and without blasting treatment.

FIG. 13 shows the thicknesses of the Ni layer 122 in the distal portions 12d and the proximal portions 12c of lateral-face covering portions 12b, in cases in which the surface of the Ni layer 122 has undergone blasting (blasted surface) and in cases in which the surface of the Ni layer 122 has not undergone blasting (non-blasted surface).

The thickness of the Ni layer 122 is from 3.1 to 3.3 micrometers on the non-blasted surface of the proximal portions 12c, and the thickness of the Ni layer 122 is from 4.2 to 4.4 micrometers on the blasted surface of the proximal portions 12c. The thickness of the Ni layer 122 is from 3.7 to 4.0 micrometers on the non-blasted surface of the distal portions 12d, and the thickness of the Ni layer 122 is from 4.6 to 5.0 micrometers on the blasted surface of the distal portions 12d.

The Ni layer 122 in the distal portions 12d is about 10 percent thicker than that in the proximal portions 12c, both on the blasted surface and on the non-blasted surface. In addition, the thickness of the Ni layer 122 on the blasted surface is about 20 percent thicker than that on the non-blasted surface, in the distal portions 12d and in the proximal portions 12c.

Accordingly, by using the masking materials 125 to create non-blasted surfaces in the proximal portions 12c and blasted surfaces in the distal portions 12d, the thickness of the Ni layer 122 in the distal portions 12d (thickest portions) of the lateral-face covering portions 12b can be at least 30 percent greater than the thickness in the proximal portions 12c. Such a large difference in the thickness of the Ni layer 122 in the distal portions 12d and in the proximal portions 12c contributes significantly to the reduction of moisture degradation and cracking.

### Second Embodiment

Next, electronic components according to other embodiments that differ from the first embodiment will be described. Electronic components according to second to fifth embodiments are the same as the capacitor according to the first embodiment, except that thicker portions in the Ni layer 122 differ, and therefore the following description will focus on the differences to omit repeated explanations.

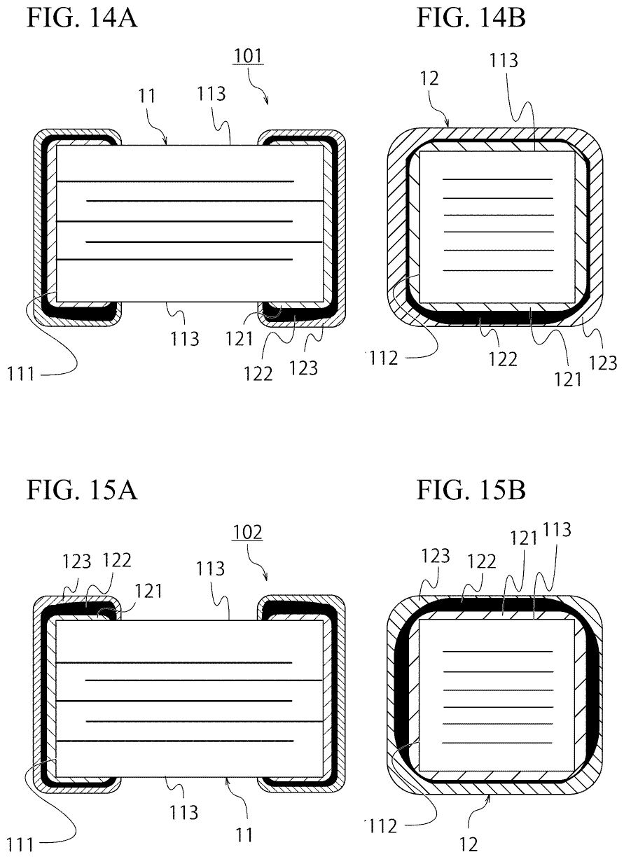

FIG. 14A is a cross-sectional view of a capacitor according to a second embodiment taken along line A-A in FIG. 1A, and FIG. 14B is a cross-sectional view thereof taken along line B-B line in FIG. 1A.

In the first embodiment, the Ni layer 122 has a thickness distribution that is common to all of the four lateral-face covering portions 12b that cover the pair of first lateral faces 112 and the pair of second lateral faces 113. In contrast, in a capacitor 101 according to the second embodiment, the Ni layer 122 has a greater thickness in a lateral-face covering portion 12b that covers a second lateral face 113 located lower in FIGS. 14A and 14B, which will face the substrate 2a after the capacitor 101 is mounted on the substrate 2a. In addition, in the second embodiment, the Ni layer 122 has a less thickness in the other lateral-face covering portions 12b that cover the other second lateral face 113 located upper in FIGS. 14A and 14B and the first lateral faces 112. The thickness of the Ni layer 122 in the lateral-face covering portions 12b over the upper second lateral face 113 and the first lateral faces 112 is the same as the thickness of the Ni layer 122 in the end-face covering portions 12a.

In other words, in the second embodiment, among the four lateral-face covering portions 12b of the external electrode 12 that surround the element body 11, the Ni layer 122 has a greater thickness in a lateral-face covering portion 12b that faces the substrate 2a and a less thickness in the other three lateral-face covering portions 12b. Cracks caused by the bending stress are likely to occur on the second lateral face 113 that faces the substrate 2a. Accordingly, the structure according to the second embodiment will reduce cracking in cases in which the bending stress is a particular problem because of factors such as the size of the capacitor 101.

### Third Embodiment

Next, an electronic component (capacitor) according to a third embodiment will be described.

FIG. 15A is a cross-sectional view of a capacitor according to a third embodiment taken along line A-A in FIG. 1A, and FIG. 15B is a cross-sectional view thereof taken along line B-B line in FIG. 1A.

In contrast to the capacitor 101 according to the second embodiment, in a capacitor 102 according to the third embodiment, the thickness of the Ni layer 122 in a lateral-face covering portion 12b that covers a second lateral face 113 located lower in FIGS. 15A and 15B, which will face the substrate 2a after the capacitor 101 is mounted on the substrate 2a, is the same as the thickness of the Ni layer 122 in the end-face covering portions 12a. In the third embodiment, the Ni layer 122 has a greater thickness in the other lateral-face covering portions 12b that cover the other second lateral face 113 located upper in FIGS. 15A and 15B and the first lateral faces 112.

In other words, in the third embodiment, among the four lateral-face covering portions 12b of the external electrode 12 that surround the element body 11, the Ni layer 122 has a less thickness in a lateral-face covering portion 12b that faces the substrate 2a and a greater thickness in the other three lateral-face covering portions 12b. Cracks caused by heat cycle are likely to occur on the second lateral face 113 that is opposite from the substrate 2a. Accordingly, the structure according to the third embodiment will reduce cracks in cases in which heat cycle cracks are particular problems because of factors such as the size of the capacitor 102.

### Fourth Embodiment

Next, an electronic component (capacitor) according to a fourth embodiment will be described.

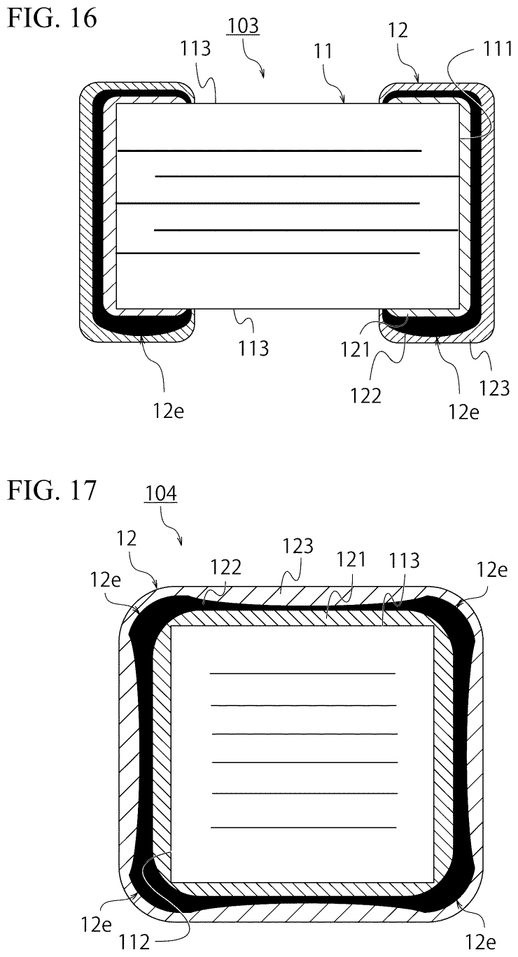

FIG. 16 is a cross-sectional view of a capacitor according to the fourth embodiment. FIG. 16 shows a cross-section taken along line A-A in FIG. 1A.

In a capacitor 103 according to the fourth embodiment, each of the Ni layers 122 of the external electrode 12 has the thickest portion in a lateral-face covering portion, in particular in the middle between the distal portion 12d and the proximal portion 12c. In the case in which the thickest portion is located between the distal portion 12d and the proximal portion 12c, both moisture degradation and cracking can also be reduced.

### Fifth Embodiment

Next, an electronic component (capacitor) according to a fifth embodiment will be described.

FIG. 17 is a cross-sectional view of the capacitor according to the fifth embodiment. FIG. 17 shows a cross-section taken along line B-B in FIG. 1A.

In a capacitor 104 according to the fifth embodiment, each of the Ni layers 122 of the external electrode 12 has the thickest portions in lateral-face covering portions 12b, in particular at the boundaries (edge lines) between the first lateral faces 112 and the second lateral faces 113. In the case in which the thickest portions of the Ni layer 122 are located over the edge lines, both moisture degradation and cracking can also be reduced.

### Sixth Embodiment

Next, an electronic component according to a sixth embodiment will be described. The electronic component according to the sixth embodiment is a chip inductor, for example.

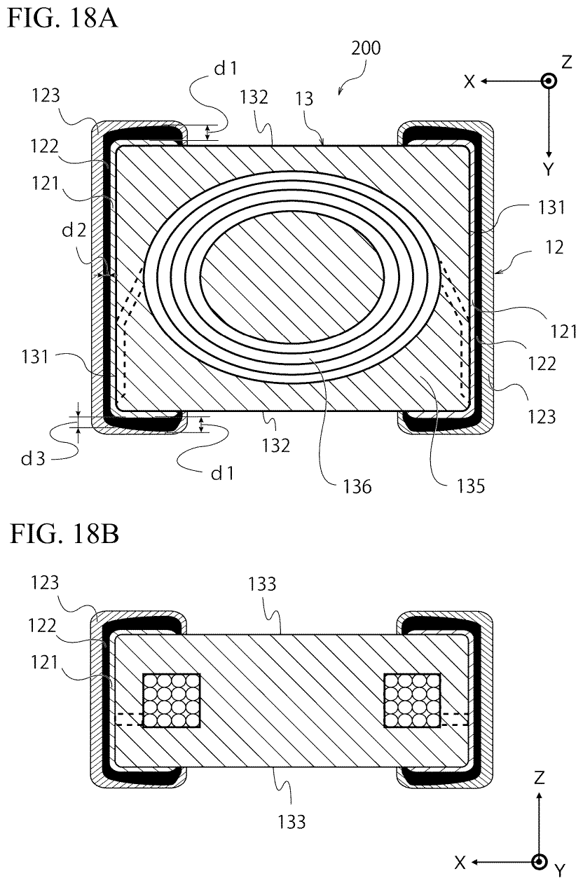

FIGS. 18A and 18B are cross-sectional views showing an example of the structure of a chip inductor according to the sixth embodiment. FIG. 18A shows a cross-section in an XY plane, and FIG. 18B shows a cross-section in an XZ plane.

The chip inductor 200 has an element body 13 and external electrodes 12.

The element body 13 has end faces 131 at both ends thereof in the length direction X, and the pair of end faces 131 are arranged opposite from each other. The element body 13 also has first lateral faces 132 at both ends thereof in the width direction Y, and second lateral faces 133 at both ends of the height direction Z.

Each of the first lateral faces 132 and the second lateral faces 133 is a surface that is connected to the end faces 131 and extends from one of the end faces 131 to the other of the end faces 131. Each of the second lateral faces 133 is a surface that is connected to both the first lateral faces 132 and both the end faces 131.

The element body 13 has a magnetic body 135 and an internal conductor 136 wound in a coil shape. The magnetic body 135 is made from, for example, ferrite.

The material for the internal conductor 136 may be a metal, for example, Cu, Fe, Zn, Al, Ni, Pt, Pd, Ag, Au, or Sn, or may be an alloy containing at least one of the metals. The internal conductor 136 reaches the end faces 131 of the element body 13, and the two ends of the internal conductor 136 are connected to a pair of external electrodes 12, respectively.

The pair of external electrodes 12 are formed on the longitudinal ends of the element body 11, so that they are separated from each other in the length direction X. Each of the external electrodes 12 is formed to cover the corresponding end face 131 of the element body 13, the neighboring portions of the first lateral faces 132, and the neighboring portions of the second lateral faces 133.

Each of the external electrodes 12 includes a base layer 121, an Ni layer 122, and an upper metal layer 123.

In the lateral-face covering portions 12b of the external electrode 12, the thickness d1 near the distal portions 12d is different from the thickness d3 near the proximal portions 12c, and the thickness d1 near the distal portions 12d is greater than the thickness d3 near the proximal portions 12c. In addition, the thicknesses d1 and d3 in the lateral-face covering portions 12b are different from the thickness d2 in the end-face covering portion 12a, and the thicknesses d1 and d3 in the lateral-face covering portions 12b are greater than the thickness d2 in the end-face covering portion 12a. In other words, the thickness of the Ni layer 122 is less in the end-face covering portion 12a, and the thickest portions of the Ni layer 122 in the lateral-face covering portions 12b exist near the distal portions 12d. As a result, both moisture degradation and cracking are reduced.

1. An electronic component comprising:
an element body having a contour having a pair of end faces and multiple lateral faces each of which is connected to the end faces and extends from one of the end faces to another of the end faces, and at least one conductor within the element body;
base layers each of which is in contact with the lateral faces and one of the end faces; and
Ni layers formed on the base layers, respectively, each of the Ni layers disposed over the lateral faces and the corresponding end face, each of the Ni layers having at least one thickest portion disposed over at least one of the lateral faces, a thickness of the thickest portion being at least 30 percent greater than a thickness of a portion of the Ni layer disposed over the corresponding end face.

2. The electronic component according to claim 1, wherein each of the base layers is a Cu layer.

3. The electronic component according to claim 2, further comprising upper metal layers formed on the Ni layers, respectively.

4. The electronic component according to claim 3, wherein each of the base layers is a Cu layer and each of the upper metal layers is an Sn layer.

5. The electronic component according to claim 1, wherein the thickness of the thickest portion is at least 20 percent greater than a thickness of at least one thinnest portion disposed over at least one of the lateral faces.

6. The electronic component according to claim 1, wherein each of the Ni layers has the thickest portions that are located over the lateral faces and that are located farther from the corresponding end face than a middle between an edge farthest from the corresponding end face and an edge closest to the corresponding end face.

7. The electronic component according to claim 1, wherein the element body has first lateral faces connected to the end faces and second lateral faces each of which is connected to the first lateral faces and the end faces, and wherein each of the Ni layer has the thickest portions disposed over boundaries between the first lateral faces and the second lateral faces.

8. The electronic component according to claim 1, wherein the thickness of the thickest portion of each of the Ni layers is from 3.5 to 5.5 micrometers.

9. The electronic component according to claim 1, wherein the thickness of the portion of each of the Ni layers disposed over the corresponding end face is from 2.5 to 4.0 micrometers.

10. The electronic component according to claim 5, wherein the thickness of the thinnest portion of each of the Ni layers is at least 3.0 micrometers.

11. The electronic component according to claim 6, wherein the thickness of the thickest portions of each of the Ni layers is at least 30 percent greater than a thickness of portions of the Ni layer disposed over boundaries between the end face and each of the lateral faces.

12. A circuit board arrangement comprising:
the electronic component according to claim 1; and
a substrate on which the electronic component is mounted via solders.

13. An electronic device comprising the circuit board arrangement according to claim 12.

14. A method of manufacturing an electronic component, the method comprising:
forming base layers on an element body that has a contour having a pair of end faces and multiple lateral faces each of which is connected to the end faces and extends from one of the end faces to another of the end faces, and at least one conductor within the element body, wherein each of the base layers is in contact with the lateral faces and one of the end faces;
reducing a thickness of at least a portion of each of the base layers, the portion being in contact with at least one of the lateral faces; and
forming Ni layers on the base layers, respectively, wherein each of the Ni layers is disposed over the lateral faces and the corresponding end face.

15. The method of manufacturing the electronic component according to claim 14, wherein reducing the thickness is performed by a blasting treatment.
